(19) United States
(12) Patent Application Publication
(10) Pub. No.: US 2011/0198222 A1
(43) Pub. Date: Aug. 18, 2011

(54) ELECTROLYTE SENSOR USING CONDUCTIVE ELASTOMER

(75) Inventors: Saket S. Bhatia, Santa Clara, CA (US); Darrell E. Davis, Sunrise, FL (US); Ankush S. Bhatia, Mumbai (IN)

(73) Assignee: Theos Medical Systems, Inc., Santa Clara, CA (US)

(21) Appl. No.: 12/946,853

(22) Filed: Nov. 15, 2010

Related U.S. Application Data
(63) Continuation-in-part of application No. 12/658,371, filed on Feb. 12, 2010.

(51) Int. Cl. G01N 27/403

(52) U.S. Cl. 204/403.01

(57) ABSTRACT

An electrolyte sensor that uses conductive elastomer electrodes. Examples of the intended analytes for sensor use include those found in urine, saliva, blood, feces and spinal fluid, although other analytes exist for electrolyte detection. Conductive elastomer trace electrodes are separated by a gap or channel which can be bridged by an electrolyte and thereby complete an electrical circuit to an alarm or other circuitry. Gap or channel distances vary the level of electrical resistance associated with detecting certain analytes.

### RELATED APPLICATIONS

This patent application is a Continuation-In-Part application that claims the priority benefit of U.S. Nonprovisional patent application Ser. No. 12/658,371 filed on Feb. 12, 2010 and titled “An Electrolyte Sensor Using Conductive Elastomer,” which is hereby incorporated by reference in its entirety.

### FIELD

The present disclosure relates to the use of conductive elastomers in electronics. More specifically, the present disclosure relates to electrodes used in sensors. More specifically, the present disclosure relates to electrodes used in a sensor to detect electrolytes including but not limited to those present in urine, sweat, blood, feces, saliva and spinal fluid.

### BACKGROUND

The approaches described in this section could be pursued, but are not necessarily approaches that have been previously conceived. Therefore, unless otherwise indicated herein, the approaches described in this section are not prior art to the claims in this application and are not admitted to be prior art by inclusion in this section.

The use of conductive polymers and conductive elastomers in commonly known in the form of gaskets or seals due to their elasticity and conductivity. Some of the useful properties as a conductor include facile shape formation, corrosion resistance, and air tight contact interface. Use as a conductor is limited however because it is difficult to obtain as low a resistivity as in metals. Conductive elastomers are typically composed of silicone rubber that has had conductive carbon or metal particles introduced. The resistivity of the material changes with conductive particle content.

The use of sensor electrodes attached electrically to an alarm unit for the purpose of treatment enuresis therapy is well known. Electrolytes present in urine enable completion of an alarm circuit by filling a gap or channel between electrodes and thereby indicating the occurrence of a micturition event. Most existing electrodes have either a set of parallel or else linear serpentine positive and negative electrode patterns whereby urine must contact both a positive and negative bare wire to complete the alarm circuit. The bare wire is made available for contact with urine through gaps in an insulator whereby the urine must enter a positive and negative gap to contact a wire and complete a circuit (see PCT/JP2006/313995 to Wada, et al.).

Separately to Wada are US 2008/0246620 and PCT/NZ2008/000331 which are limited to circuit completion along a single narrow gap between two conductive plastic zone halves, each half respectively in contact with one positive conductive element and one negative conductive element that extend into the sensor body from a terminal socket. This is disadvantageous because an electrolyte could be present in one of the plastic zone halves and never close the electric circuit whereby the entire sensor surface is comprised only of the two zone halves. The present disclosure is not limited in this way whereby conductive elastomer positive and negative trace electrodes are connected to respective wire terminal lead ends and whereby the conductive elastomer trace electrodes are in close proximity to each other throughout a sensor “trace pattern” so that an electrolyte can close the circuit by simultaneously touching any point along the surface of a positive and a negative trace electrode throughout the entire trace pattern which takes up the entire sensor surface. This is an important improvement given that a penis or other electrolyte source is unpredictable in electrolyte placement and whereby the volume or amount of electrolyte required to close a circuit should be as low as possible and corresponding circuit completion as quick as possible for effective therapy where every moment counts in training the nervous system. Examples of sensor trace patterns are illustrated in FIG. 2A-2L.

Another advantage over the existing solutions is the use of heat molding to attach the trace electrodes. Considerably larger and more robust than existing sensor films or printed circuits, the present heat molded elastomeric electrodes are able to withstand both being worn overnight by a user as well as degradation by caustic substances such as urine. A “wetness sensor” is described in US 2008/0041792 to Crnkovich, et al. that detects leaks from catheter sites using exclusively a circuit printed onto a solid nonflexible support. Such a circuit would not withstand the caustic effect of urine combined with continuous overnight use by a wearer.

Sensors used to detect electrolytes present in things other than urine would operate on the same principle of forming a conductive bridge between sensor electrodes whereby the function of the completed circuit operates to contribute to different forms of therapy depending on what is being detected by the sensor, the upstream electronics and what human system is being treated. Examples of additional purposes include detecting blood or spinal fluid leaking from catheter sites and sensing feces in a diaper. These examples are not exclusive from other uses but instead are meant to describe some of the utilities for the use of conductive elastomer in sensor electrodes and where it is illustrated that a conductive elastomer electrode is universally an improvement over the existing solutions for many reasons but especially because electrolytes can contact any part of the surfaces of the robust conductive elastomer trace electrodes and result immediately in a current whereas the existing solutions require additional time for electrolytes to come into contact with interspersed metal wire contact points or be of sufficient volume and directionality to connect plastic electrode zone halves.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

An electrolyte sensor using conductive elastomer disclosed herein is a sensor for detecting electrolytes including but not limited to those present in urine, sweat, saliva, feces, spinal fluid and blood and is capable of acting as a sensor for any electrolyte. It is to be understood that the term ‘electrolyte’ includes but is not limited to those electrolytes present in sweat, blood, urine, feces, saliva or spinal fluid. An example of the utility for the electrolyte sensor using conductive elastomer is in the area of enuresis treatment whereby the sensor is attached to an alarm circuit that is activated by the presence of urine on the sensor. The sensor is comprised of positive and negative conductive elastomer trace electrodes, a base portion or portions, and a gap or channel or pluralities thereof separating the electrodes. The “positive” and “negative” trace electrodes are defined as those electrodes which are respectively connected to positive and negative wire terminal leads which are in turn ultimately connected to positive and negative battery terminals. The conductive elastomer trace electrodes are preferably heat molded over a highly flexible nonconductive silicone base portion whereby a gap or channel separates positive from negative trace electrodes throughout the pattern.

The trace electrodes may sit on top of the base portion or may be recessed into the base portion; the gap or channel may comprise a spatial void using available air as a gaseous insulator or, whereby recessed electrodes are separated by a gap or channel comprised of physical insulating material such as the silicone in the base portion. The gap or channel is not limited to an even size whereby gaps or channels may be of even or uneven size or sizes throughout the trace pattern. Electrolytes such as those present in urine make a conductive bridge across the channel or gap between adjacent positive and negative traces causing a circuit to be closed whereby the electrolytes present in urine are capable of conducting an electric charge between the positive and negative trace electrodes. The circuit is closed in connection with either an alarm unit or a transmitter capable of sending a signal to a remote alarm or other electronics unit. In some example embodiments, the electrolyte sensor using conductive elastomer comprises an electrolyte sensor.

In some example embodiments, the electrolyte sensor using conductive elastomer improves the speed with which a sensor for detecting an electrolyte alarms the presence of the electrolyte by making sensor electrodes out of conductive elastomer whereby the conductive elastomer is able to conduct a current at any point along its entire surface whereby an electrical circuit is closed between a positive conductive elastomer electrode and a negative conductive elastomer and whereby the positive and negative electrodes are connected to a power source with metal wires, additional portions of conductive elastomer or in any manner whereby a current is supplied to the sensor portion electrodes.

In some example embodiments, the electrolyte sensor using conductive elastomer improves the specificity of the sensor to react to a desired electrolyte by making electrolyte sensor electrodes out of conductive elastomer whereby the elastomer composition and the size of the gap or channel between electrode traces is a function of the amount of electrical resistance required to be overcome in forming a current across the gap.

In some example embodiments, the electrolyte sensor using conductive elastomer may improve the functional shape of a urine sensor by making urine sensor electrodes out of conductive elastomer and connecting them via a trace pattern to a highly flexible silicone base portion whereby the penis can change positioning during the night and whereby conductive elastomer electrode traces can be patterned to detect urine over a useful area of virtually any shape.

In some example embodiments, the electrolyte sensor using conductive elastomer improves the state of the art of electrolyte detection by lessening the amount of electrolyte required to activate an electrolyte sensor by making electrolyte sensor electrodes out of conductive elastomer.

In some example embodiments, the electrolyte sensor using conductive elastomer improves the flexibility of electrolyte sensors by making electrolyte sensor electrodes out of conductive elastomer and with a flexible silicone base portion or bridge portions.

In some example embodiments, the electrolyte sensor using conductive elastomer improves the comfort of electrolyte sensors worn by users by making electrolyte sensor electrodes out of conductive elastomer and the base portion out of flexible silicone by virtue of inherent properties of elastomer including relative warmth to the touch, and whereby the silicone base portion is made with soft rounded edges and corners. Also adding to the comfort is the replacement of metal in the sensor surface with elastomer thereby minimizing the use of hard, sharp materials in sensor construction.

In some example embodiments, the electrolyte sensor using conductive elastomer improves the durability of electrolyte sensors through heat molding electrolyte sensor electrodes and lead wires to a silicone base.

In some example embodiments, the electrolyte sensor using conductive elastomer improves the corrosion resistance of electrolyte sensors by making electrolyte sensor electrodes out of conductive elastomer instead of metal wires.

The characteristics and utilities of the example embodiments described in this summary and the detailed description below are not all inclusive. Many additional features and advantages will be apparent to one of ordinary skill in the art given the following drawings, specifications and claims.

### BRIEF DESCRIPTION OF DRAWINGS

Embodiments are illustrated by way of example and not limitation in the figures of the accompanying drawings, in which like references indicate similar elements and in which:

FIG. 1 is a perspective view showing the incoming electrode wire terminals attached to a base member and the electrode traces, in accordance with an example embodiment.

FIGS. 2A-L show various electrode trace patterns as patterns made available, in accordance with an example embodiment.

FIG. 3 is an exploded side view of a sensor with an island type electrode pattern, in accordance with an example embodiment.

### DETAILED DESCRIPTION

Example embodiments of are described. In the following description, for purposes of explanation, numerous specific details are set forth in order to provide a thorough understanding of example embodiments. It will be evident, however, to one skilled in the art, that the present invention may be practiced without these specific details.

The present disclosure relates to an electrolyte sensor that is preferably used for the detection of sweat, blood, urine, feces, saliva and spinal fluid, all containing electrolytes capable of enabling conduction of an electric current between electrodes and it is to be understood that the term “electrolyte” includes but is not limited to those present in the following analytes: sweat, blood, urine, feces, saliva or spinal fluid. The present disclosure is also generally intended to allow the measurement of electrical resistance across electrode gaps of any possible analyte.

The advantages described herein may come by making electrolyte sensor electrodes with conductive elastomer and enjoying the properties which allow including flexibility in designing sensor shape and area (relating, for example, to penis or urine or electrolyte source location variability), improved conductive sensitivity to electrolytes as a function of electrode area versus reaction time, sensor corrosion resistance, sensor conductive exclusivity to sweat, blood, urine, feces or spinal fluid, sensor flexibility and comfort, and sensor durability due to heat molded construction.

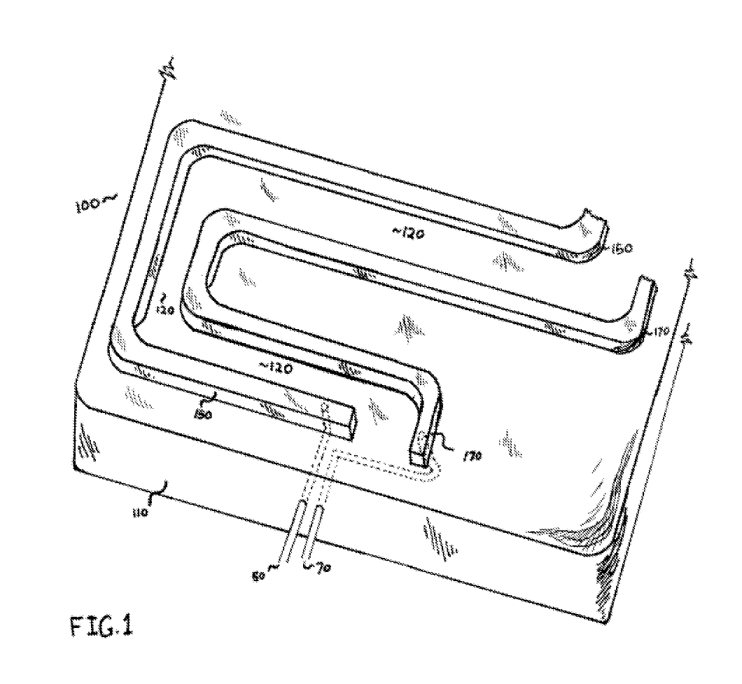

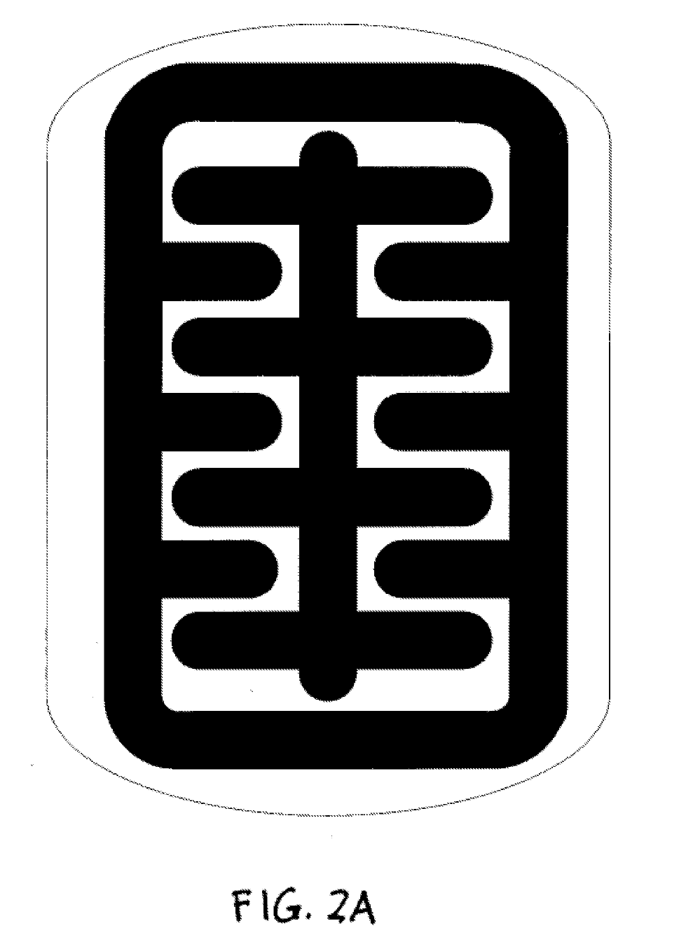

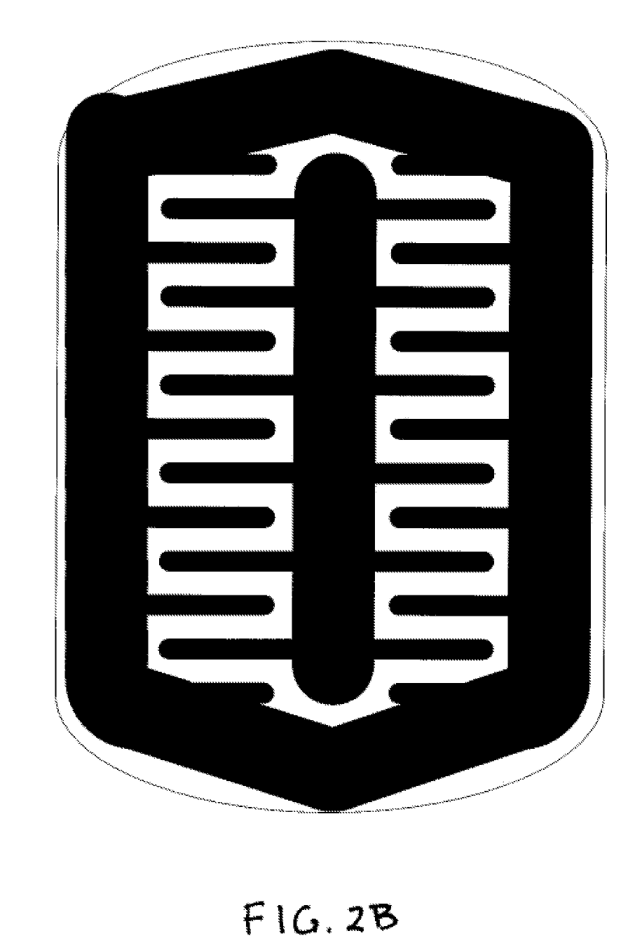

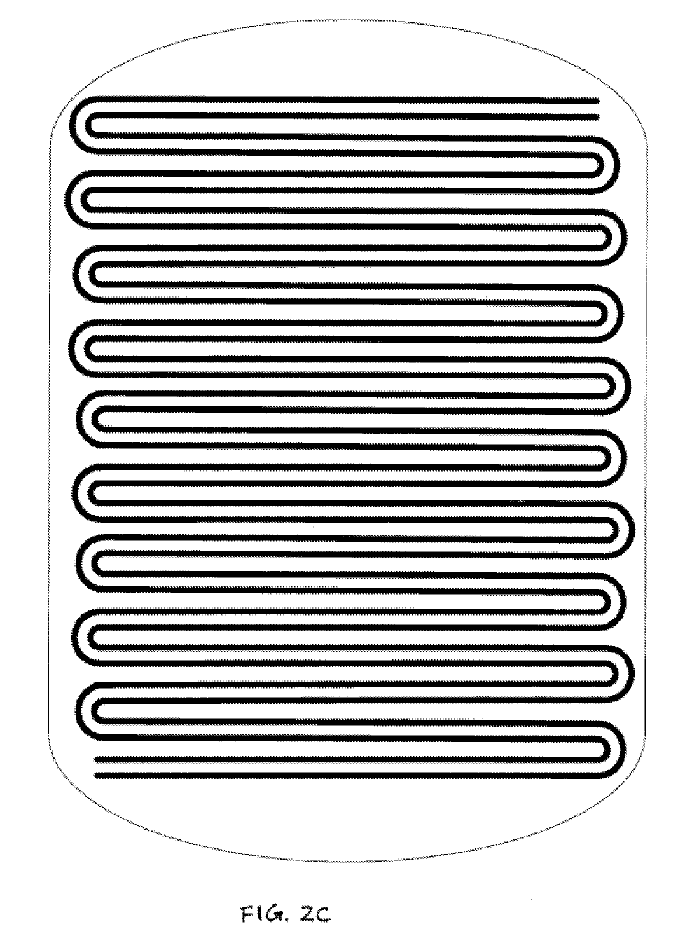

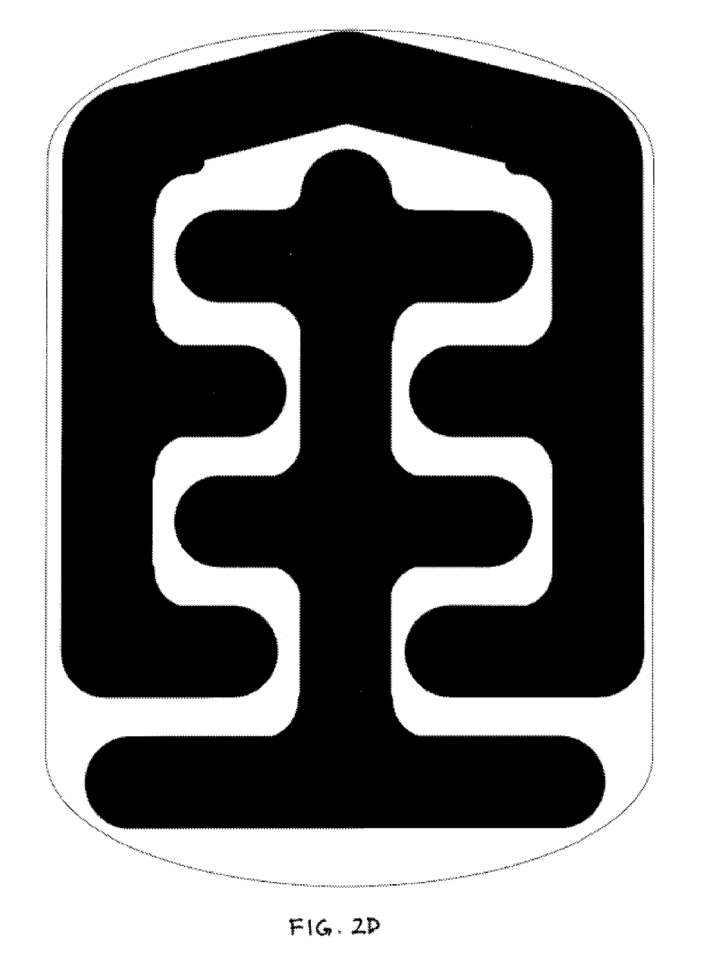

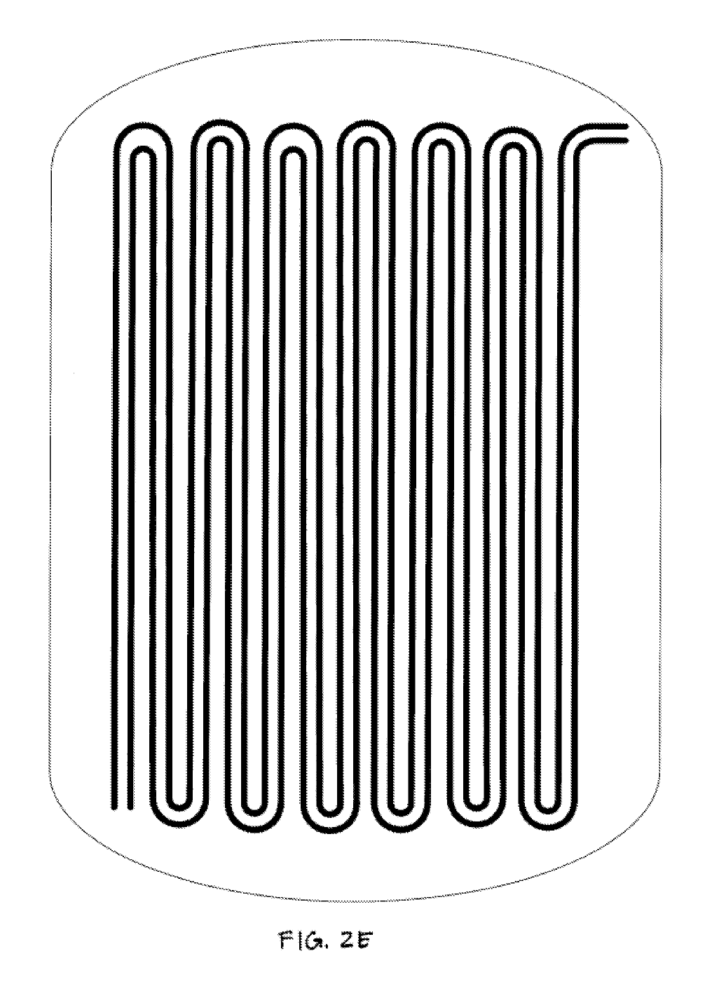

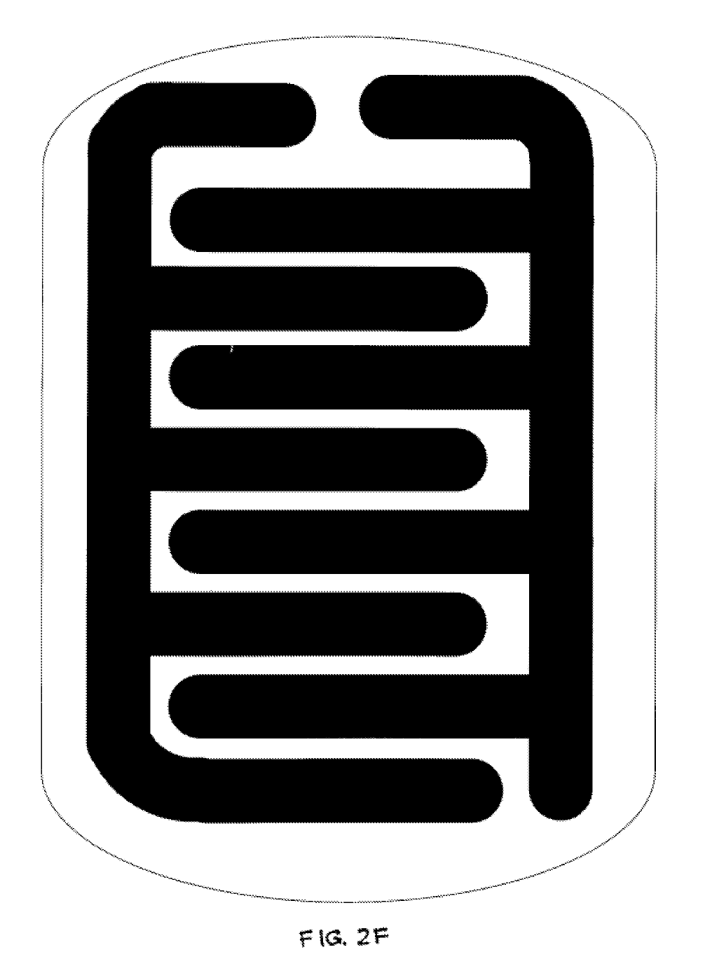

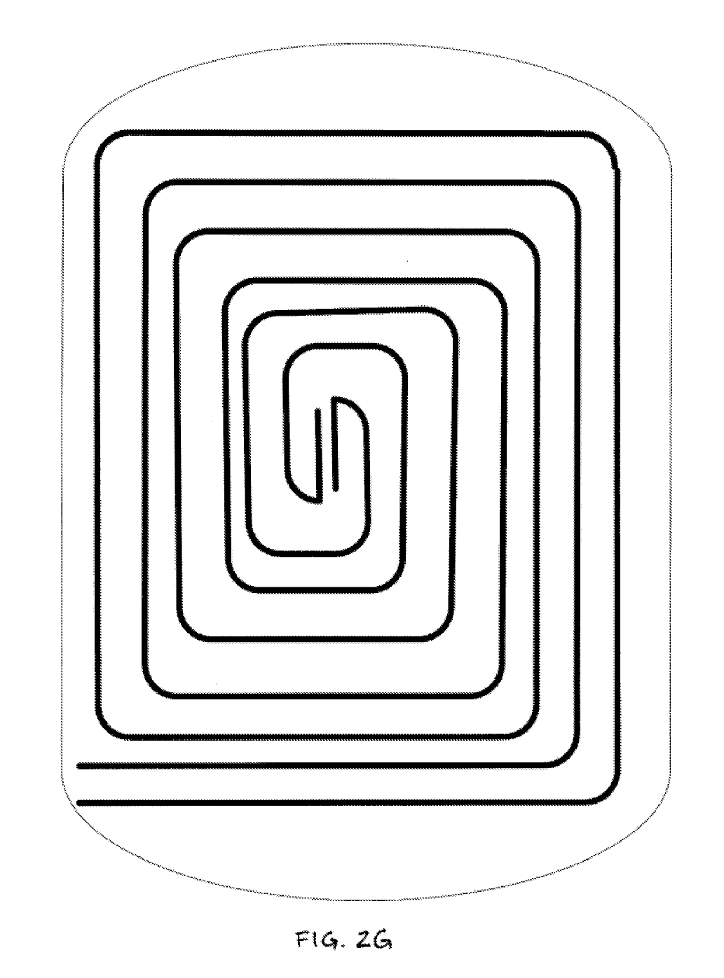

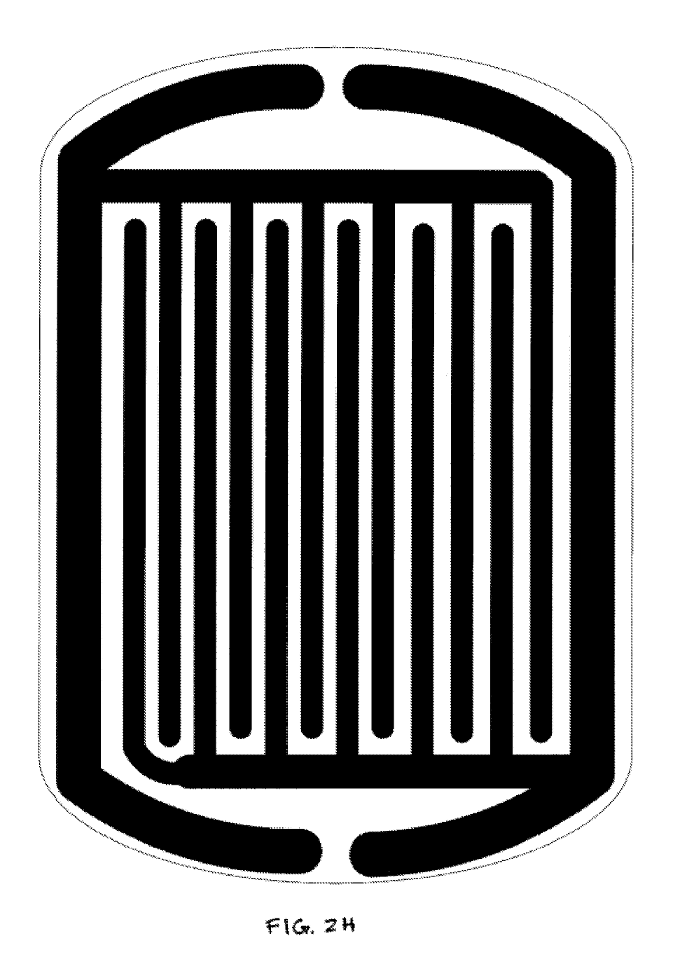

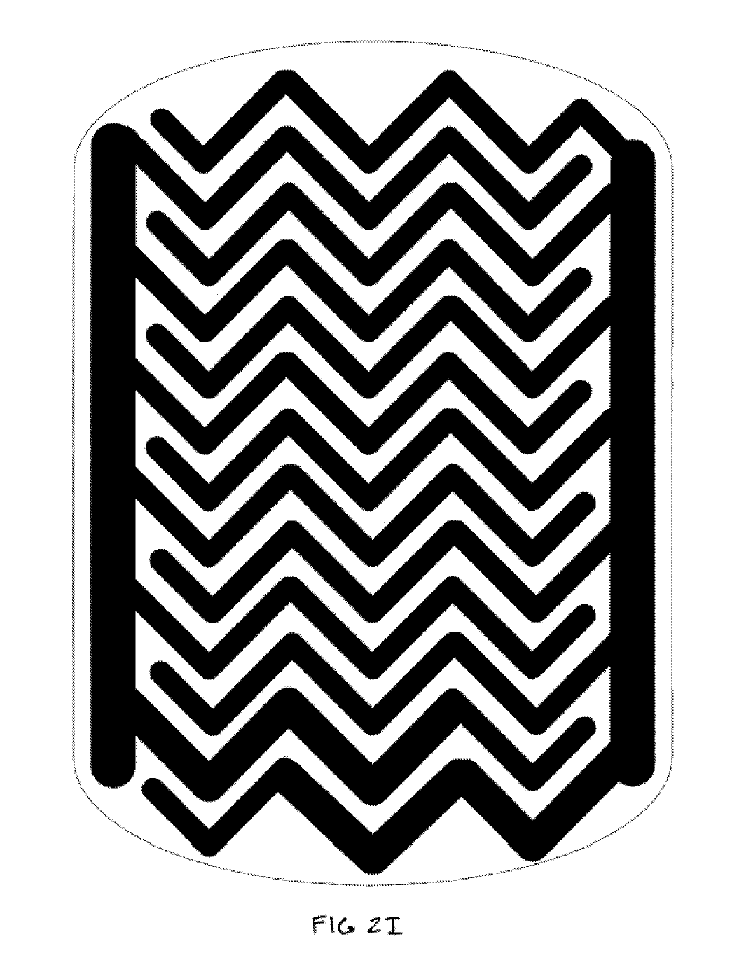

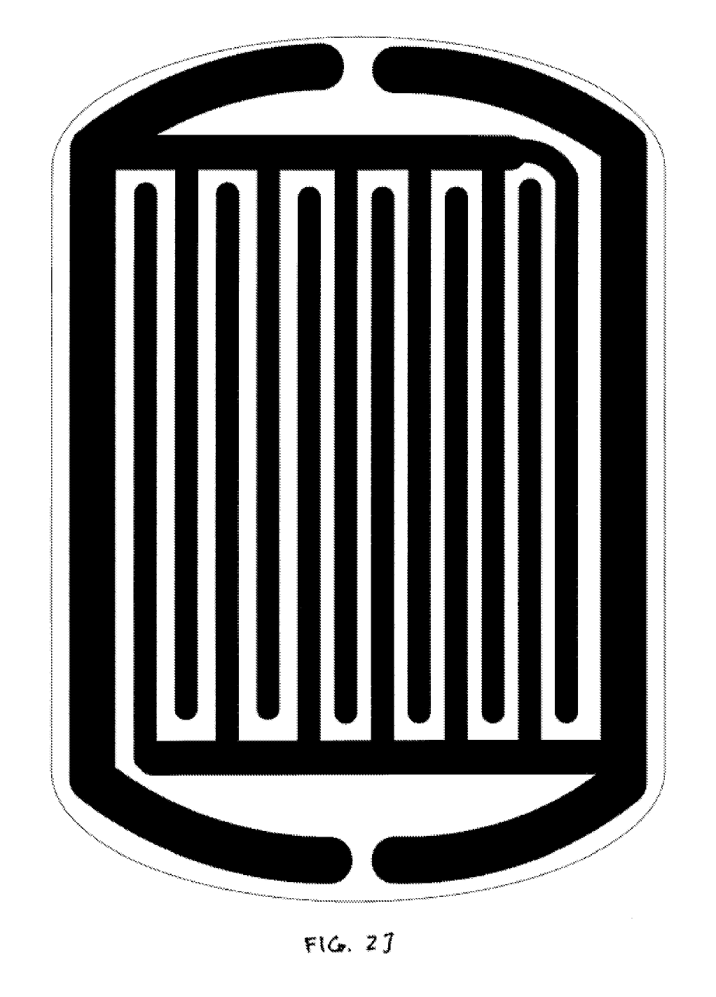

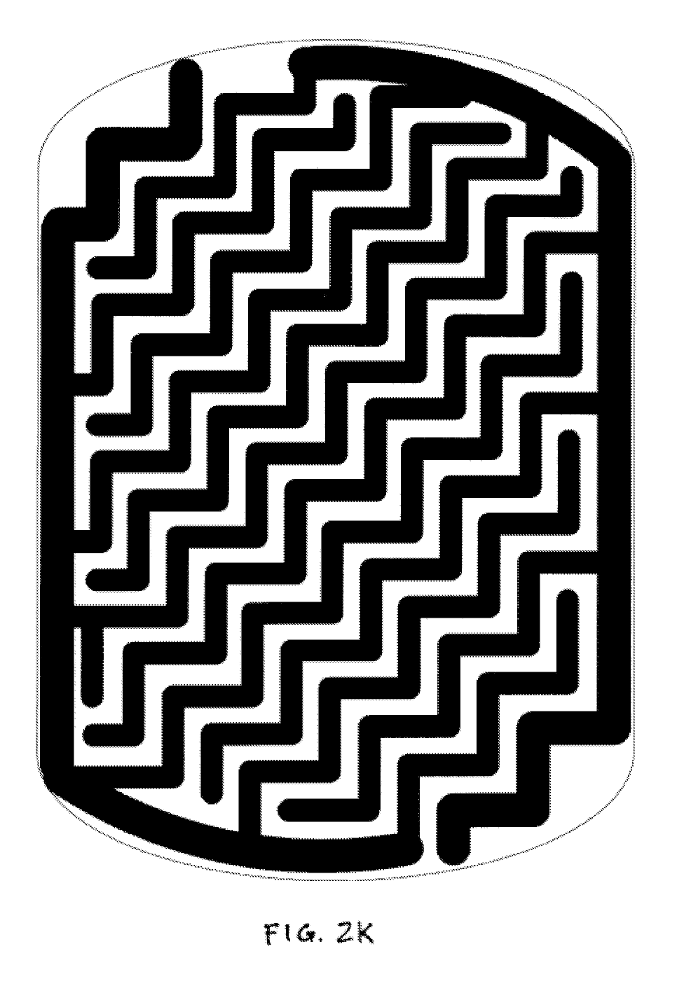

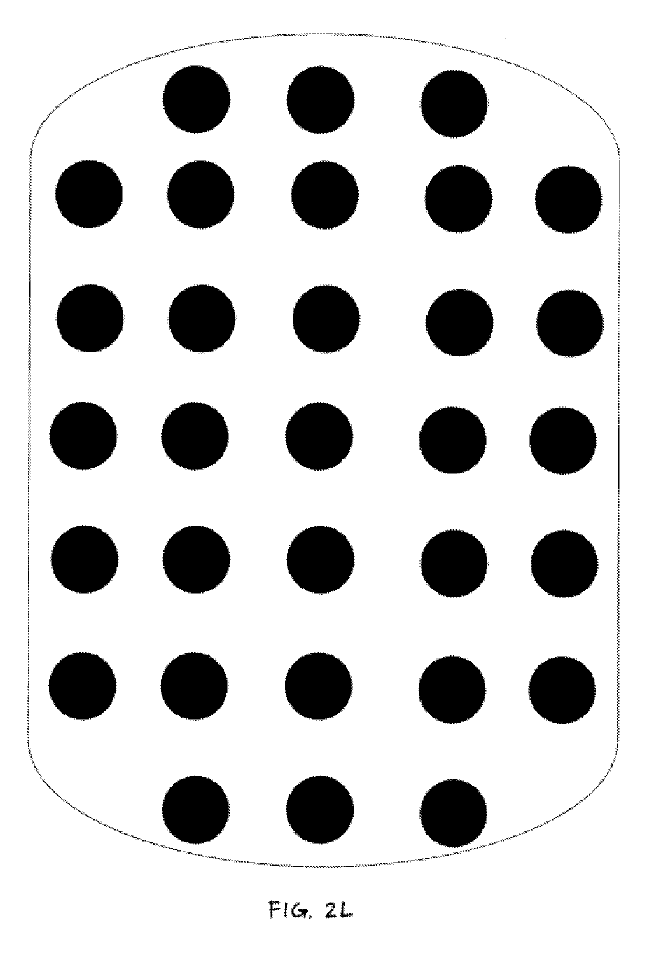

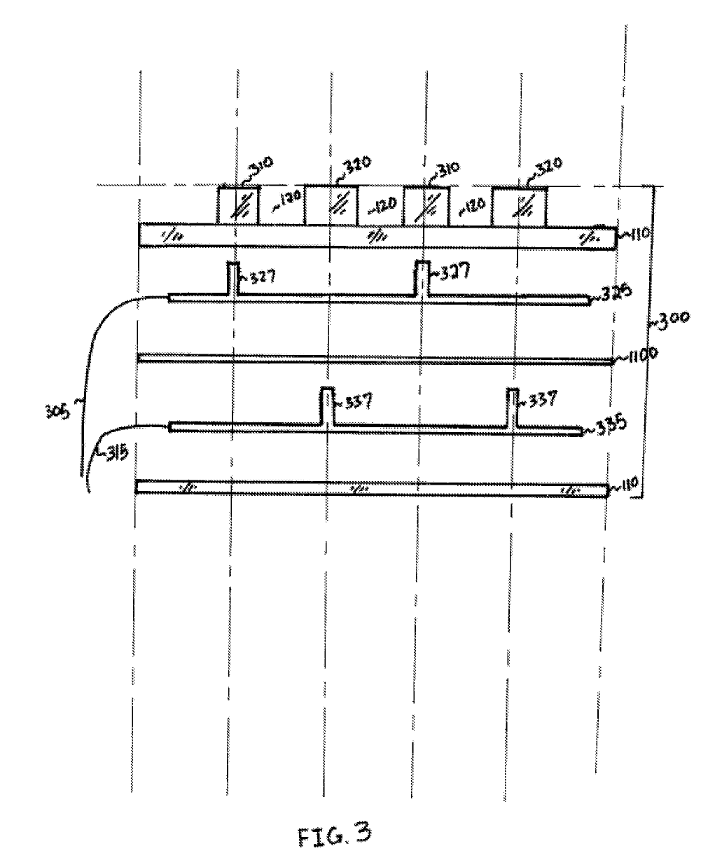

FIG. 1 is a perspective view showing the incoming electrode wire terminals attached to a base member and the electrode traces. FIGS. 2A-L show various electrode trace patterns as examples of the patterns made available by the present invention. FIG. 3 is an exploded side view of a sensor with an island type electrode pattern. Along with linear style trace electrodes, herein “trace electrodes”, is an additional preferred embodiment for electrode pattern design comprising a plurality of spaced apart “electrode islands”, herein “islands”. See FIG. 2L and FIG. 3. Sensor composition, whereby an island pattern is used, comprises connecting terminal wires 305, 315 to separate positive and negative overlaid planar conductive grids 325, 335 that are separated from each other by an insulating layer 1100 within the base portion 110. The planar grids 325, 335 have corresponding small positive and negative posts 327, 337 that protrude perpendicularly from the planar grids and through insulating material to an outer surface of the base portion 110. The positive and negative protruding posts are positionally offset to one another and elastomer is heat molded to each. The result is a plurality of elastomeric island electrodes 310, 320 that are alternating cylindrical or non-cylindrical positive and negative electrodes separated physically and electrically by gaps 120 which may be then filled with or distanced across by electrolyte whereby a circuit may be closed.

The chemical process for producing conductive elastomer is well known and principally comprises mixing elastomer with conductive particles. It should be understood that numerous equivalent compounds could be used to create elastomeric compounds capable of forming a suitable positive or negative electrode. Additionally, the compounds used may be classified as polymeric as opposed to elastomeric. The preferred embodiment of the elastomer composition for the present disclosure is indicated in a chart below.

Means for separating positive and negative trace electrodes 150, 170 or islands 310, 320 in order to maintain the desired distance or distances between electrodes include but are not limited to the preferred method of heat molding the electrode traces 150, 170 or islands 310, 320 to a base member 110 at a desired distance or distances from each other, and alternatively the use of nonconductive “bridges” between electrodes whereby a base portion may or may not be used. The preferred embodiment is use of the nonconductive silicone base member 110 whereby the incoming terminal leads 50, 70 or 305, 315 are connected to the trace electrodes 150, 170 or islands 310, 320 by heat molding to the electrode traces or islands and the base member 110 to prevent or make difficult the dislodgement of the terminal ends in use. Bare terminal wire leads 50, 70 or 305, 315 are positioned proximally to a portion of a respective electrode. Silicone from a silicone base portion 110 is melted around the bare terminal wires 50, 70 or 305, 315 and the connection vulcanized. Heat molding the terminals 50, 70 or 305, 315 to the electrodes has the additional advantage of freeing manufacture of the sensor from the physical and financial constraints associated with shaping metal wires into a trace pattern in favor of an elastomer trace mold.

Heat molding is also the preferred means for connecting the wire terminals 50, 70 or 305, 315 to the silicone base portion. The present disclosure also anticipates use of rivets, screws, frictional and/or compression connecting means.

It is anticipated that the terminal wires 50, 70 or 305, 315 may be connected directly to an alarm or other electronics unit or that the terminal wires may be connected to a transmitter unit which may transmit to a remote alarm or other electronics unit. It is separately anticipated that the sensor 100 may have more than one sensing surface whereby the base portion 110 may contain more than one surface upon which to place elastomer trace electrodes with same or different trace patterns on the surfaces.

Conductive elastomer traces comprising the positive and negative trace electrodes 150, 170 or islands 310, 320 are arranged with a channel or gap 120 separating the positive and negative trace electrodes whereby the channel or gap distance is defined as the distance between a positive electrode or portion thereof and the nearest negative electrode or portion thereof. The size of the channel or gap distance between the electrodes is defined as a functional size that is determined by the conductive ability of electrolytes to quickly form a circuit bridge between the positive and negative conductive elastomer trace electrodes whereby without the electrolytes the channel or gap distance size would cause the circuit to remain open. It is anticipated that the electrolytes can bridge positive and negative electrodes that are not only one gap or channel distance from each other but may alternatively bridge positive and negative traces separated by numerous gaps or channels, or may employ gap or channel distances of uneven size or sizes. It is therefore established that the anticipated embodiments of the gap or channel distance between traces, and the related embodiments of trace widths or areas, are to be understood to comprise a functional value limited only by the conductivity of a given electrolyte across a certain distance and between electrodes carrying current of a certain resistance level. The non-limiting preferred embodiment for the distance between positive and negative electrodes comprising the gap or channel distance is 1-20 mm, and the preferred embodiment for the size of trace widths or diameters is 1-20 mm.

It is further to be understood that the present disclosure anticipates unequal size gaps or channel distances, as well as varying trace sizes in the same sensor. However, the preferred embodiment is to have trace electrode patterns with gap or channel distances and/or trace widths or diameters that operate within a size range as needed for detection of a given electrolyte. See FIGS. 2A-2L.

It is also to be understood that the present disclosure anticipates an embodiment whereby nonconductive silicone or an equivalent material is employed to form small bridges placed at functional intervals that function to separate the conductive elastomer trace electrodes from each other thereby establishing and maintaining the gap or channel or a plurality of gaps or channels between electrodes. However, it is the preferred embodiment of the present disclosure to utilize a nonconductive silicone base 110 as the separation means to create the gap or channel 120 between electrode traces whereby the conductive elastomer traces 150, 170 or islands 310, 320 are attached to a nonconductive silicone base 110 in such a manner that a gap or channel 120 is established between them and whereby the preferred attachment means for attaching the electrode traces to the base is heat molding. The preferred compositions for the conductive elastomer traces and the silicone base are shown in the charts below:

Conductive Elastomer

| | |
|---|---|
| Silicone: Methyl Vinyl Silicone Rubber (Dimethyl Polysiloxane) | 57% |
| Conductive Carbon Black: Acetylene Carbon (Acetylene Black) | 42% |
| Hardener: 2.5-2.5-2-methyl t-butyl peroxy-2 ethane (Dimethyl-2.5 | 1% |
| Di(Tertiary-Butyl Peroxy)Hexane) | |

Insulating Rubber Silicone Base (Sensor Base)

| | |
|---|---|
| Silicone: Methyl Vinyl Silicone Rubber (Dimethyl Polysiloxane) | 99% |
| Hardener: 2.5-2.5-2-methyl t-butyl peroxy-2 ethane (Dimethyl-2.5 | 1% |
| Di(Tertiary-Butyl Peroxy)Hexane) | |

Given the above functional definition for electrode trace embodiments, it is possible for numerous trace patterns with correlating gaps or channels between positive and negative conductive elastomer traces to function equivalently. Some of these examples are represented in FIGS. 2A-2L. It is to be understood therefore that those trace patterns using the above functional definition are equivalents to one another and that the preferred embodiment is to be understood more precisely as a range of values for gap or channel distance and related trace width or area (diameter).

Thus, embodiments of the electrolyte sensor using conductive elastomer have been described. Although the embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

1. An electrolyte sensor for detecting an analyte, the electrolyte sensor comprising one or more positive and negative trace electrodes, the positive and negative trace electrodes including a conductive polymer and arranged in a pattern of proximity with respect to each other throughout a surface of the electrolyte sensor so that the analyte closes an electrical circuit by touching the surface.

2. The electrolyte sensor of claim 1, wherein the one or more positive and negative trace electrodes are connected to respective terminal lead ends, the terminal lead ends being connected to respective positive and negative battery terminals.

3. The electrolyte sensor of claim 1, wherein the polymer is an elastomer.

4. The electrolyte sensor of claim 1, wherein the proximity between the positive and negative trace electrodes is sufficient to prevent establishing of an electric current between the positive and negative trace electrodes.

5. The electrolyte sensor of claim 1, wherein the proximity is formed by one or more gaps or channels of an uneven dimension.

6. The electrolyte sensor of claim 5, wherein the positive and negative trace electrodes form islands throughout the surface, the one or more gaps or channels separating the islands.

7. The electrolyte sensor of claim 5, wherein an electrical resistance is measured across the one or more gaps or channels and the analyte includes one or more of the following: a solid, a liquid, and a gas.

8. The electrolyte sensor of claim 5, wherein the one or more gaps or channels are of sufficient respective sizes to allow the analyte present in a solid, liquid or gas to conduct electricity between the one or more positive and negative trace electrodes.

9. The electrolyte sensor of claim 1, wherein the one or more positive and negative trace electrodes are separated by one or more bridges.

10. The electrolyte sensor of claim 1, wherein the one or more positive and negative trace electrodes are arranged on a flexible nonconductive base portion, the flexible nonconductive base portion enabling separation of the one or more positive and negative trace electrodes and being of a sufficient rigidity a distance between the positive and negative trace electrodes.

11. The electrolyte sensor of claim 1, wherein the one or more positive and negative trace electrodes are attached to the flexible nonconductive base portion by heat molding and vulcanization or by an adhesive.

12. The electrolyte sensor of claim 1, wherein the flexible nonconductive base portion includes a silicone.

13. The electrolyte sensor of claim 1, wherein the analyte includes one or more of the following: urine, blood, saliva, spinal fluid, sweat, and feces.
